(19) United States
(12) Patent Application Publication
(10) Pub. No.: US 2011/0217530 A1
(43) Pub. Date: Sep. 8, 2011

(54) CONVERSION FILM AND METHOD FOR PRODUCING THE SAME

(75) Inventors: Andrea Maier-Richter, Hong Kong (CN); Eckard Foltin, Sinzig (DE); Thomas Bernert, Leverkusen (DE); Wilfried Hedderich, Hilden (DE); Thomas Wagner, Hasselroth (DE)

(73) Assignee: Bayer MaterialScience AG

(21) Appl. No.: 13/061,764

(22) PCT Filed: Aug. 22, 2009
(86) PCT No.: PCT/EP09/06114

§ 371 Date: May 19, 2011

(30) Foreign Application Priority Data
Sep. 4, 2008 (EP) 08015571.6

(51) Int. Cl. B32B 7/02; B32B 17/06; B32B 19/00; B32B 27/00; B32B 27/34; B32B 27/40; B32B 3/00

(52) U.S. Cl. 428/216; 428/426; 428/688; 428/411.1; 428/500; 428/474.4; 428/473.5; 428/423.1; 428/337

(57) ABSTRACT

The invention relates to a conversion film for a light-emitting element, said film containing a conversion pigment. The invention further relates to a method for producing the conversion film, to the use thereof and to a light-emitting element equipped with said conversion film.

The invention relates to a conversion film containing a conversion pigment for a light-emitting clement, to a method for producing this conversion film, to its use and to a light-emitting element equipped with this conversion film.

For use in illuminating the human environment (ambient illumination), the lighting industry is particularly interested in light sources that generate white light, since it is this which is most similar to natural light.

Owing to their low power consumption and their long lifetime, above all LEDs, but also electroluminescent lamps (electroluminescence lamps, EL lamps), have become ever more interesting and popular in recent years.

These light sources, however, have the disadvantage that they only emit monochromatic light, i.e. light with only one light colour. For LEDs, these are in particular the light colours blue, green, yellow, orange, red, violet or monochromatic UV light, i.e. UV LEDs, and for electroluminescent lamps they are in particular the light colours blue, green or orange.

In order to overcome this disadvantage, for example, white light sources based on LEDs are produced by combining blue, green and red LEDs.

As an alternative, organic or inorganic conversion pigments are used in order to generate white light with monochromatic light-emitting elements. To this end, the light-emitting elements are coated with conversion pigments. This method can be employed both for LEDs and for EL lamps.

The colour of the white light (light temperature) of such a light source then depends on the conversion pigment, its concentration and the original wavelength of the radiation of the light-emitting element. The homogeneity of the emitted light is determined by the uniformity in the distribution of the conversion pigment on the light-emitting element.

Thus, for example, conversion pigments may absorb a part of the e.g. blue light of an LED and emit longer-wavelength yellow light. Additive colour mixture of the remaining blue light and the yellow light generated by the colour layer gives white light for the observer. In principle, the colour locus of the emitted light can be adjusted on a line between the colour loci of the blue LED and of the conversion pigment in the CIE 1931 standard chromaticity diagram. The UV LEDs and blue LEDs which are used have an emission maximum in the range of from 240 to 510 nm, preferably from 460 to 475 nm, particularly preferably 464 nm.

In order to convert the e.g. blue light of an LED into white light, U.S.-A-2007/0291196 proposes a coated sheet which can polarise light and also has conversion properties. The various layers are however adhesive layers, for example layers of pressure sensitive adhesive (PSA), which makes production of this sheet elaborate and leads to a comparatively thick sheet. In other methods, the conversion pigment is put into a dispersion, for example with epoxy resins or silicone, and applied for example by dripping, spraying, blowing or atomisation onto the light-emitting element, preferably an LED, so that the dispersion forms a layer containing the conversion pigment on the light-emitting element. WO-A-97/50 132, WO-A-01/65 613 and U.S.-A-2005/0062140 disclose examples of such methods. The non-uniform, inhomogeneous distribution of the conversion pigment in the dispersion due to the dispersing method, and therefore that of the resulting layer, causes inhomogeneous emission of the converted light. Since the human eye is particularly sensitive to colour differences of white light, it is necessary to sort (bin) the light-emitting elements in order to obtain as far as possible those with only one light colour (light temperature). This downstream sorting process is very resource-intensive, since each individual light-emitting element has to be measured and correspondingly clustered.

EP-A-1 643 567 addresses this problem and provides, as a light-emitting element, a light-emitting diode chip in which the conversion layer (converter layer, i.e. a layer containing conversion pigments) is deliberately structured in order to adjust a dependency of the resulting colour locus on an observation angle. The conversion layer is particularly preferably applied and structured by screen printing. It is to be noted that the conversion layer is applied directly onto the main surface of the semiconductor layer sequence, i.e. directly onto the light-emitting diode chip. The main surface of the semiconductor layer sequence may be provided either in the form of a wafer for a multiplicity of light-emitting diode chips, or in the form of already diced light-emitting diode chips.

Owing to the small size of the structures to be applied, for example 18 μm, this method is however inaccurate when the structures are applied at the same time as the screen printing, so that the aforementioned binning is still required. In order to increase the accuracy, the structures may be applied after the screen printing, for example lithographically. Fewer rejects will then be obtained during the binning. However, an additional method step is required, which makes this method more elaborate and more expensive.

It was therefore an object of the invention to overcome the disadvantages of the prior art. In particular, it was an object of the invention to provide a light-emitting element which avoids inhomogeneous emission of the converted light, i.e. ensures homogeneous emission of the converted light. Structuring of the conversion layer is intended to be made superfluous. The element should preferably be thin, straightforwardly manufacturable reproducibly by a standardised method, and individualisable in respect of the conversion pigments to be used and the associated light colour (light temperature). Trimming of the element, for example by cutting or stamping, should be readily possible in accordance with the application by subsequent fabrication steps. It was another object of the invention to provide a method for producing this element.

In particular, the object is achieved by a conversion film which contains conversion pigments and has homogeneous conversion properties. This is achieved by homogeneous distribution of the conversion pigments in a conversion layer and/or conversion layers of the conversion film over the entire layer surfaces of the conversion layer(s).

The invention provides a conversion film for a light-emitting element. This conversion film contains a substrate A and one or more conversion layer(s) B comprising conversion pigments, preferably one, two three or four conversion layer(s) B1, B2, B3, B4.

According to the invention, the conversion film preferably also has light-scattering properties, and is thus used as a scattering film.

A scattering film is intended to mean a film with the ability to deviate the direction of the incident light rays by refraction of light, so that the emerging light is substantially emitted diffusely, i.e. uniformly in all directions. This capacity may, for example, be achieved by the roughness of the substrate or by scattering pigments. These scattering pigments may be incorporated in or applied on the substrate or any layer applied onto the substrate. In the scope of the invention, the conversion pigment may also be used as a scattering pigment.

A conversion layer in the scope of the invention is intended to mean a layer containing a conversion pigment. A conversion pigment in the scope of the invention is also intended to mean a mixture of two or more different conversion pigments. These conversion pigments may contain additional scattering pigments.

Homogeneous, in the scope of the invention, means that the conversion properties are the same over the entire extent of the conversion film with the conversion pigment printed on it. Conversion properties are intended to mean the transmissivity for the light wavelength of the light-emitting element and the emissivity for the converted light wavelengths. The conversion properties are determined by recording the spectral emission characteristic of the light-emitting element (intensity as a function of wavelength) with a spectral camera (for example with an LMK 98-4 from Techno Team), and comparing it with the spectral diagram in terms of the colour locus with a conversion film applied. As an alternative, a digital photograph (with a colour-calibrated camera) may be evaluated with respect to intensity (brightness) and colour locus.

Homogeneous conversion properties in the scope of the invention are intended in particular to mean that the differences of the conversion properties in the conversion layer(s) of the conversion film from one measurement point with a size of from 0.005 to 0.05 mm², preferably from 0.01 to 0.02 mm², to any other measurement point with the same size are less than or equal to Δx=0.2 and Δy=0.2 for the colour coordinates x and y in the CIE 1931 colour space, preferably not more than Δx=0.035 and Δy=0.035, more particularly preferably not more than Δx=0.025 and Δy=0.025, more particularly preferably not more than Δx=0.017 and Δy=0.017.

The aforementioned properties preferably apply according to the invention to a printed conversion film for the regions which lie at least about 5 to 10 mm from the outer edge of the printed region in the conversion film's region with conversion pigment printed on it, i.e. the inner region of the printed conversion film, and also to the entire finished conversion film, since this inner region of the printed conversion film is free from production-related inhomogeneities and the finished conversion film is for example cut or stamped out from this inner region.

Achieving these properties does not require any particular or elaborate fabrication method, such as would be, necessary for coating wafers or individual light-emitting diode chips according to EP-A-1 643 567. The rejection of from 5 to 10 mm on the outer edge of the conversion film entails only a negligible loss for a printed film area of the order of from 0.01 m² to 1 m², and preferably film edge lengths which are approximately equal and/or at least 100 mm or more, this loss being commensurately less when the area of the printed film is larger. The area of the printed film may also be selected to be larger or smaller, according to the fabrication method available in situ or other specifications, larger areas generally being preferred on the basis of the edge effects. In the method according to EP-A-1 643 567, excluding from 5 to 10 mm on the outer edge would be economically unviable in the case of a wafer and out of the question in the case of a light-emitting diode chip.

The conversion properties of the inner region of the printed conversion film and of the finished conversion film likewise preferably apply on the condition that the radiation emitted by the light-emitting clement essentially strikes the large surface of the conversion film perpendicularly, and the deviation from perpendicular should be less than 30°, preferably less than 15°, particularly preferably less than 7.5°.

A finished conversion film in the scope of the invention is intended to mean a conversion film with which the light-emitting element can be equipped in order to convert monochromatic light into white light, i.e. the conversion film after the end of production, including trimming. For trimming, the conversion film may be processed by methods such as cutting or stamping, whether mechanically, thermally, by tools, lasers, liquids, compressed gases etc.

In the scope of the invention, the conversion film obtained before trimming is referred to as a printed conversion film.

If the features of the printed and finished conversion films are the same, only the expression conversion film will be used for both of them.

The term “light-emitting element” in the scope of the invention is intended to mean:
light-emitting semiconductor elements, preferably LEDs, OLEDs, PLEDs;
electroluminescent elements, preferably inorganic and/or organic thick-film and/or thin-film elements.

The conversion layer of the conversion film is preferably produced by methods of application onto a substrate, for example by printing methods such as screen printing, flexographic printing or gravure printing, or by film casting or casting-spreading methods. Of these, the conversion layer is preferably produced by a screen printing method, more preferably by flatbed and rotary screen printing. In particular with printing methods, more particularly with screen printing methods, standardised, well-reproducible and homogeneous layers can readily be produced with conventional machines. The printed conversion film may, for example, be obtained as a semifinished product and used for further trimming in the form of sheet- or roll-ware, in all technically feasible sizes.

In so far as is technically realistic, further layers of the conversion film, in particular translucent colour layers, may also be produced by application methods.

The area of the substrate, which is coated with conversion pigment during production of the printed conversion film by application methods and which is therefore the area of the printed conversion film, is a multiple larger than the area of the finished conversion film i.e. the conversion film after trimming. Since the conversion film is preferably completely flat, no edge effects with regard to homogeneous distribution of the conversion pigment occur in the finished conversion film. This applies in particular with the proviso that the finished conversion film is taken from the inner region of the printed film, i.e. for example cut or stamped out. Both for the finished conversion film and for the inner region of the printed conversion film, there is a homogeneous distribution of the conversion pigment and a constant layer thickness, by virtue of which the homogeneous conversion properties are obtained.

The conversion film according to the invention obviates the need to sort the light-emitting elements, since the conversion pigments arc distributed uniformly in the conversion layer. The pigments do not agglomerate in the layer. On average, there is the same concentration of pigments at every position on the finished conversion film so that all light-emitting elements, which are equipped with the conversion film according to the invention, have the same light colour (light temperature). In the case of light-emitting elements which are equipped with a layer containing a conversion pigment according to prior art methods, this is not guaranteed.

Quality inspection both of the printed conversion film and of the finished conversion film according to the invention is economically viable both in-line and off-line. The final colour temperature is determined by the type of conversion pigment, the fill factor of the conversion layer, the thickness of the conversion layer, the number of layers which are applied, and the original emission wavelength of the light-emitting element. This colour temperature is ascertained after the end of the method and, with the same method conditions, it is reproducible.

So that the day design of the light-emitting element can be selected freely, the conversion film with the conversion layer printed on it may be provided with a translucent colour layer. For example, the conversion layer of the present invention may be yellow in colour, in order to generate white light in the case of a blue LED as the light-emitting element, or it may have another colour in order to generate arbitrary colours with the three primary colours e.g. of an LED (red, blue and green). According to the invention, translucent is intended to mean an optical transmission of more than 20%, preferably more than 30%, and particularly preferably more than 40% of the incident light. The colour of the translucent colour layer may be selected arbitrarily. Translucent inks are known in the prior art and to the person skilled in the art, for example inks from Pröll KG. This coating may be applied onto the conversion layer, or onto the side of the substrate A which faces away from the conversion layer. It is necessary to ensure that, as far as possible, the translucent colour layer lies behind the conversion layer as seen from the light-emitting element.

The translucent colour layer may, however, also be applied onto a separate film. This film, which may also have scattering properties, may then be applied onto the side of the conversion film which faces away from the light-emitting element. This may be done directly or indirectly, for example by means of a bonding agent layer, for example an adhesive or a laminatable (adhesive) layer. A bonding agent layer may, however, also be obviated. In particular, it is feasible to avoid the bonding agent layer or the adhesive being a pressure sensitive adhesive (PSA). This will simplify production of the conversion film. This is possible by production of the conversion film preferably being carried out according to the invention by an application method, preferably by a printing method, more preferably by a screen printing method. A translucent colour layer on the conversion layer may then be obviated. As an alternative, however, the film comprising a translucent colour layer may also be applied over the conversion film so that there is a gas, preferably air, between the two films. This has the advantage that the conversion layer will be scarcely perceptible through the translucent colour layer. A translucent colour layer on the conversion film may also be obviated in this case.

The conversion film according to the invention comprises a substrate A and one or more conversion layers B, preferably one, two three or four conversion layers B1, B2, B3 or B4.

Optionally, the conversion film may furthermore contain the following layers: one or more protective layer(s) C, preferably one, two three or four protective layers C1, C2, C3 or C4, optionally one or more translucent layer(s) D, preferably one, two three or four translucent colour layers D1, D2, D3 or D4, optionally one or more graphics layer(s) E, preferably one or two graphics layers E1, E2. Optionally, at least one of the said layers may be connected to at least one other of the said layers and/or to the substrate A and/or to a cover film by one or more interlayer(s), preferably one or more bonding agent layer(s). As already disclosed above, bonding agent layers may be obviated by virtue of producing the conversion film, as is preferred according to the invention, by an application method, preferably with production by a printing method, more preferably by a screen printing method. In particular, it is feasible to avoid the bonding agent layer or layers being pressure sensitive adhesive (PSA). This will simplify production'of the conversion film.

The conversion film preferably has the following structure:

### EMBODIMENT I

On the side which faces away from the light-emitting element, the conversion film is constructed as follows:
   1) substrate A;
   2) one or more conversion layers B thereon;
   3) optionally one or more translucent colour layers D thereon;
   4) optionally one or more protective layers C and/or a cover film thereon;
and on the side which faces towards the light-emitting clement, the substrate A optionally comprises one or more protective layers C and/or a cover film;
   or

### EMBODIMENT II

On the side which faces towards the light-emitting element, the conversion film is constructed as follows:
   1) substrate A;
   2) optionally a translucent colour layer of several translucent colour layers D thereon;
   3) one or more conversion layers B thereon;
   4) optionally one or more protective layers C and/or a cover film thereon;
and on the side which faces away from the light-emitting element, the substrate A has the following structure:
   6) optionally one or more translucent colour layers D;
   7) optionally one or more protective layers C and/or a cover film thereon;
      or

### EMBODIMENT III

On the side which faces towards the light-emitting clement, the conversion film is constructed as follows:
   1) substrate A;
   2) optionally one or more translucent colour layers D thereon;
   4) one or more conversion layers B thereon;
   5) optionally one or more protective layers C and/or a cover film thereon;
and on the side which faces away from the light-emitting element, the substrate A optionally comprises one or more protective layers C and/or a cover film.

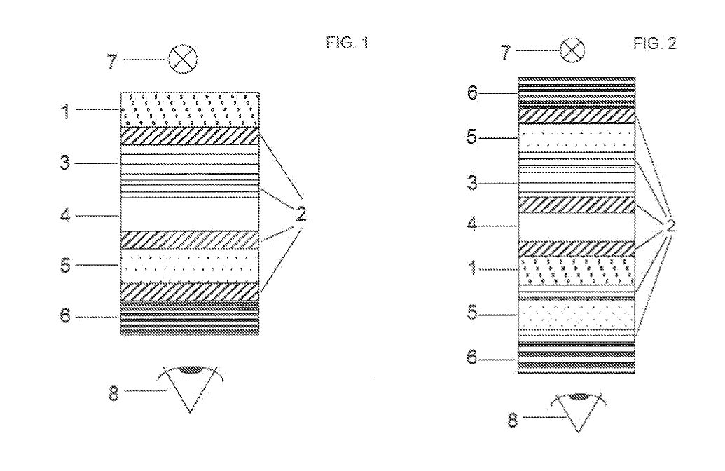

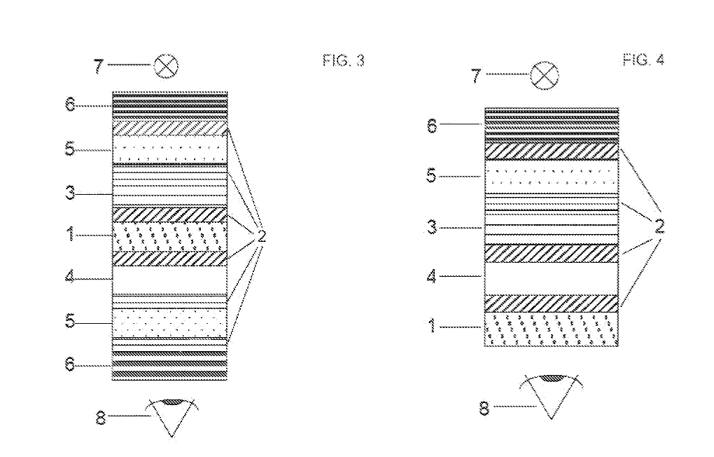

Exemplary embodiments may be found in FIGS. 1 to 4.

The graphics layer(s) are preferably applied on the side of the conversion layer(s) which faces away from the light-emitting element.

Preferably, the substrate A is a film with a thickness of from 10 to 2000 μm, preferably from 70 μm to 500 μm, particularly preferably from 100 μm to 375 μm, more particularly preferably from 125 μm to 275 μm.

Preferably, the substrate A is a plate having a thickness of from 500 μm to 10,000 μm, preferably from 750 μm to 6000 μm, particularly preferably from 2000 μm to 5000 μm.

The substrate A consists essentially or entirely of glass, for example a glass pane or a glass lens, or a ceramic panel or a ceramic lens, or a polymer material preferably formed as a film or plate, preferably selected from the group consisting of the polymers polyethylene (PE), polypropylene (PP), polyvinyl chloride (PVC), polyethylene. terephthalate (PET), cellulose triacetate (CTA), ethylene vinyl acetate (EVA), polyvinyl acetate (PVA), polyvinyl alcohol, polyvinyl butyral (PVB), polyvinyl chloride (PVC), polyester, polycarbonate (PC), polyethylene naphthalate (PEN), polyurethanes (PU), thermoplastic polyurethanes (TPU), polyamides (PA), polymethyl methacrylate (PMMA), cellulose nitrate and/or copolymers of at least two of the monomers of the aforementioned polymers and/or mixtures of two or more of these polymers. The transparency of the said materials, i.e. the glass, ceramic or polymer material, should not be less than 50%, preferably 70%, particularly preferably 90%. That is to say the substrate A has a transparency of 50% or more, preferably 70% or more, particularly preferably 90% or more. Besides those mentioned, any other sufficiently transparent materials are likewise suitable.

In the event that three-dimensional shaping of the conversion film is intended, the substrate should preferably be made from at least one cold-stretchable film material. Isostatic high-pressure shaping is therefore possible at a method temperature below the softening temperature of the substrate. Suitable cold-stretchable film materials are mentioned, for example, in EP-A-0 371 425. It is possible to use both thermoplastic and thermosetting, at least partially transparent cold-stretchable film materials. It is preferable to use cold-stretchable film materials which have little or no restoring capacity at room and working temperatures. Particularly preferred film materials are selected from at least one material in the group consisting of polycarbonates, preferably polycarbonates based on bisphenol A, for example the Makrofol® brands marketed by Bayer MaterialScience AG, polyesters, in particular aromatic polyesters, for example polyalkylene terephthalates, polyamides, for example the PA 6 or PA 6,6 types, high-strength “aramid films”, polyimides (PI), for example films based on poly(diphenyl oxide pyromellitimide), polyarylates (PAR), organic thermoplastic cellulose esters, in particular their acetates, propionates and acetobutyrates and polyfluorohydrocarbons, in particular copolymers of tetrafluoroethylene and hexafluoropropylene, which are available in transparent form. Preferred film materials are selected from polycarbonates, preferably polycarbonates based on bisphenol A, for example the Makrofol® brands marketed by Bayer MaterialScience AG, polyesters, in particular aromatic polyesters, for example polyalkylene terephthalates, and polyamides, films based on poly(diphenyl oxide pyromellitimide). It is more particularly preferable to use polycarbonates based on bisphenol A as film materials, in particular films with the designation Bayfol® CR (polycarbonate/polybutylene terephthalate films), Makrofol® TP or Makrofol® DE from Bayer MaterialScience AG.

The substrate A in the scope of the invention is expressly not intended to mean a semiconductor layer sequence or its main surface, as disclosed in EP-A-1 643 567.

Both organic and inorganic pigments are suitable as a conversion pigment. As organic pigments, for example, it is possible to use so-called daylight pigments such as the T series or FTX series from Swada or the daylight pigments from Sinloihi, for example the FZ-2000 series, FZ-5000 series, FZ-6000 series, FZ-3040 series, FA-40 series, FA-200 series, FA-000 series, FM-100, FX-300 or SB-10.

As materials for inorganic pigments, it is possible to use garnets or oxynitrides, for example (Y, Gd, Lu, Tb)₃(Al, Ga)₅O₁₂ doped with Ce, (Ca, Sr, Ba)₂SiO₄ doped with Eu, YSiO₂N doped with Ce, Y₂Si₃O₃N₄ doped with Ce, Gd₂Si₃O₃N₄ doped with Ce, (Y, Gd, Tb, Lu)₃Al₃Al₅₋ₓSiₓO₁₂₋ₓNₓ doped with Ce, BaMgAl₁₀O₁₇ doped with Eu, SrAl₂O₄ doped with Eu, Sr₄Al₁₄O₂₅ doped with Eu, (Ca, Sr, Ba)Si₂N₂O₂ doped with Eu, SrSiAl₂O₃N₂ doped with Eu, (Ca, Sr, Ba)₂Si₂N₈ doped with Eu, CaAlSiN₃ doped with Eu; molybdates, tungstates, vanadates, nitrides and/or oxides of boron, aluminium, gallium, indium and thallium, in each case separately or mixtures thereof with one or more activators such as Ce, Eu, Mn, Cr and/or Bi.

If the conversion film comprises a plurality of conversion layers, then the various layers may also contain different conversion pigments, although it is also possible for them all to contain the same conversion pigment.

The thickness of the conversion layer, or the sum of the thicknesses of the conversion layers, is from 1 to 300 μm, preferably from 20 to 200 μm, particularly preferably from 50 to 100 μm, the thickness of an individual layer preferably not being less than 1 μm. An individual layer may be applied in a single application process, in particular a printing process, or in a plurality of printing processes. With higher fill factors of conversion pigment in the conversion layer(s), for the same conversion properties, the thickness of the conversion layer or the sum of the thicknesses of the conversion layers can be kept smaller than in the case of lower fill factors.

For example, with a 40 wt. % fill factor of conversion pigment in the printing paste for producing the conversion layer, the thickness of the conversion layer will preferably be about 75 to 95 μm in order to convert the blue light of an LED, for example with radiation at a wavelength of 464 nm, into white light for the observer.

In order to produce the said printing paste for the conversion layer, raw coating materials for example based on polyurethanes will be used, in particular Desmodur® and/or Desmophen® as well as Bayhydur® and Bayhydrol® from Bayer MaterialScience AG. It is furthermore possible to use finished nonpigmented screen printing pastes from companies such as, for example, Pröll (Noriphan® HTR 093, a coating based on synthetic resin), Marabu, Coates Screen, DuPont etc. (3M Scotchcal® and Scotchlite®). These coatings, pastes or raw material formulations are tilled with from 1 to 99 wt. %, preferably with from 10 to 80 wt. %, particularly preferably from 20 to 77 wt. %, more particularly preferably from 35 to 72 wt. % of the conversion pigments described above. In order to adjust the correct viscosity for screen printing, the pastes may be diluted with suitable solvents, for example with water, ethyl acetate, butyl acetate, 1-methoxy-2-propyl acetate, toluene, xylene, Solvesso 100, Shellsol A, Noriphan® HTR 097 (solvent/retarder based on ethyl 3-ethoxypropionate) from Pröll or mixtures of two or more of these solvents. One- or preferably two-component polyurethane systems may be used as binders, for example from Bayer MaterialScience AG (for example Desmodur®) and/or Desmophen®) or binders based on polyvinyl butyral, for example the material marketed as Mowital® by Kuraray Europe GmbH, or polymethyl methacrylate. Furthermore, additives such as flow control agents and rheological additives may be added to the paste in order to improve the properties.

For example, a formulation for producing a conversion layer by the screen printing method contains 40.2 wt. % of conversion pigments, (Ca, Sr, Ba)₂SiO₄ doped with Eu from Leuchtstoffwerke Breitungen, 45.9 wt. % of Noriphan® HTR 093 from Pröll and 13.9 wt. % of Noriphan® HTR 097 from Pröll. Another formulation according to the invention contains for example 39.2 wt. % of conversion pigments (Ca, Sr, Ba)₂SiO₄ doped with Eu from Leuchtstoffwerke Breitungen, 44.8 wt. % of Noriphan® HTR 093 from Pröll and 16.0 wt. % of Noriphan® HTR 097 from Pröll.

According to the invention, UV-drying coating systems may also be used to produce the conversion layer. For example 100%, solvent-containing or aqueous, UV-setting polyurethane coatings may be used. These have the advantage that they are flexible and are therefore particularly suitable for parts which are to be shaped subsequently.

The invention also provides a method for producing the conversion film according to the invention. As already mentioned, the conversion film can be produced by known application methods. It is preferably produced by printing methods, in particular screen printing. Compared with conventional dispersion methods, printing methods are standardised and reproducible.

The method preferably comprises the following steps:
(1) providing a substrate A, preferably as a sheet or from a roll;
(2) applying the conversion pigments dispersed in a paste, preferably by the screen printing method, in order to produce the conversion layer B;
(3) drying and/or polymerising and/or crosslinking the conversion layer on the substrate A.

For the screen printing, for example, a screen with a screen grade of 43 threads/cm may be used. Other usable screen grades lie between 20 and 120 threads/cm, in particular 25, 36, 68, 77, 90, 120 threads/cm.

Steps (1), (2) and (3) are preferably carried out successively in this order.

The aforementioned step (2) or the aforementioned step (3), or steps (2) and (3), may respectively be repeated one, two, three or more times individually and/or in alternation, the first performance of step (2) following steps (1).

In order to adjust the colour locus of the light-emitting element equipped with the conversion film, it is possible to select the number of printed layers for an individual conversion layer and/or the number of conversion layers. Thus, it is possible to print only one layer for an individual conversion layer, or two, three, four or five printed layers (i.e. in a sequence) wet or wet in wet above one another. The fill factor of conversion pigment within an individual layer may be equal to or different from the fill factor of one or more other layers. This makes it possible to adjust the colour locus accurately.

The further layers, which the conversion film may contain, can be applied by any methods according to the prior art, screen printing methods preferably being used in so far as is technically realistic and possible.

After fabrication of the printed conversion film, the finished conversion films can be obtained from it by trimming, according to the invention preferably from the inner region. The finished conversion films in technical production have an area of from 1 to 100 mm², preferably from 2 to 50 mm², particularly preferably from 4 to 25 mm², although it is possible to cut out both larger and smaller conversion films depending on the trimming method and the desired application. The finished conversion film according to the invention may be applied arbitrarily onto or over a light-emitting element in the beam path of the light. Thus, it is possible to cover either a single small LED with a conversion film or to cover full surfaces having LED arrays or even large-area EL lamps.

It is furthermore possible to equip a light-emitting element with more than one conversion film having one or more conversion layers, if a multilayer structure is desired or necessary.

In an alternative embodiment of the invention, the substrate A may be removed after application of the conversion layer(s) and optionally one layer or several layers selected from interlayer(s), translucent colour layer(s), protective layer(s). protective film(s). In this alternative embodiment, it is not necessary for the transparency of the substrate A to be 50% or more, and it may readily be much less. The conversion film is then formed by the applied layer(s). These layer(s) then fulfil the task(s) of the substrate A (for example the carrying/supporting and/or the optional scattering effect of the substrate A). In the scope of the invention, these layer(s) represent the conversion film for this alternative embodiment after removal of the original substrate A. Thus, with suitable materials, the conversion film may for example consist only of the conversion layer, which fulfils both the function of the substrate A and that of the conversion layer B. Preferably, the substrate A is removed after one of the steps of drying, polymerisation and/or crosslinking (3), more preferably after the last step (3). The conversion film obtainable by this alternative embodiment may be further processed and used in the same way as the conversion films according to the invention which were disclosed above.

The invention furthermore provides the use of the conversion film according to the invention for equipping light-emitting elements, in particular light-emitting semiconductor elements, preferably LEDs (light emitting device, light-emitting element), OLEDs (organic light emitting device, organic light-emitting element), PLED (polymer light emitting device, polymer light emitting element) and electroluminescent elements, preferably inorganic and/or organic thick-film and/or thin-film elements.

The invention furthermore provides a device containing a light-emitting element, which is characterised in that the light-emitting element is equipped, preferably covered with at least one conversion film according to the invention. This light-emitting element, equipped with the conversion film according to the invention, may additionally be equipped with a film comprising a translucent colour layer and also have scattering properties.

In the scope of the invention, “covered” is intended to mean that the light used for the application shines through the conversion film. The light is thereby fully or partially converted in colour. The conversion film may be bonded directly onto the light-emitting element by a transparent adhesive, or applied on a package which contains the light-emitting element, for example by adhesive bonding, plugging or another mechanical fastening method, or applied suitably on a printed circuit board or flexible conductor track, on which the light-emitting element is located.

Particularly in the case of a three-dimensionally shaped conversion film, it may be screwed onto the package of the light-emitting element.

Between the light-emitting element and the conversion film, there may be one or more substantially transparent adhesive layers, further film layers or air.

The final colour temperature is determined by the type of conversion pigment, the number and thickness of the conversion layer(s), the geometrical shape of the two-or three-dimensionally configured conversion film, and the original emission wavelength of the light-emitting element. This colour temperature is ascertained after the light-emitting clement has been equipped with the conversion film according to the invention and optionally with a film comprising a translucent colour layer, and, with the same method conditions, it is reproducible.

### LIST OF REFERENCES

1 substrate A
2 interlayer(s)
3 conversion layer B
4 translucent colour layer D
5 protective layer C
6 protective film
7 light-emitting element
8 observer

1. Conversion film for a light-emitting element, containing a substrate A and one or more conversion layer(s) B comprising conversion pigments, characterised in that the substrate essentially or entirely consists of glass or a ceramic, or of a polymer material.

2. Conversion film according to claim 1, characterised in that the substrate A has a transparency of 50% or more, preferably 70% or more, particularly preferably 90% or more.

3. Conversion film according to claim 1 or 2, characterised in that the polymer material is selected from the group consisting of the polymers polyethylene (PE), polypropylene (PP), polyvinyl chloride (PVC), polyethylene terephthalate (PET), cellulose triacetate (CTA), ethylene vinyl acetate (EVA), polyvinyl acetate (PVA), polyvinyl alcohol, polyvinyl butyral (PVB), polyvinyl chloride (PVC), polyester, polycarbonate (PC), polyethylene naphthalate (PEN), polyurethanes (PU), thermoplastic polyurethanes (TPU), polyamides (PA), polymethyl methacrylate (PMMA), polyimide (PI), polyarylate (PAR), cellulose nitrate, cellulose ester, polyfluorohydrocarbons and/or copolymers of at least two of the monomers of the aforementioned polymers and/or mixtures of two or more of these polymers.

4. Conversion film according to one of claims 1 to 3, characterised in that the conversion film comprises one or more protective layers C and/or a cover film in addition to the conversion layer(s) B.

5. Conversion film according to one of claims 1 to 4, characterised in that the conversion film comprises one or more translucent colour layers D and/or one or more graphics layers E in addition to the one or more conversion layer(s) B.

6. Conversion film according to one of claims 3 to 5, characterised in that the substrate A is a film having a thickness of from 10 μm to 2000 μm, preferably from 70 μm to 500 μm, particularly preferably from 100 μm to 375 μm, more particularly preferably from 125 μm to 275 μm.

7. Conversion film according to one of claims 3 to 5, characterised in that the substrate A is a plate having a thickness of from 500 μm to 10,000 μm, preferably from 750 μm to 6000 μm, particularly preferably from 2000 μm to 5000 μm.

8. Conversion film according to one of claims 1 to 7, characterised in that the thickness of the conversion layer, or the sum of the thicknesses of the conversion layers, is from 1 to 300 μm, preferably from 20 to 200 μm, particularly preferably from 50 to 100 μm, the thickness of an individual layer preferably not being less than 1 μm.

9. Conversion film according to one of claims 1 to 8, characterised in that the light-emitting element is a light-emitting semiconductor clement, preferably an LED, an OLED, an PLED or an electroluminescent element.

10. Method for producing a conversion film according to one of claims 1 to 9, characterised in that the conversion layer(s) is or are applied onto the substrate A by an application method, preferably by a printing method, particularly preferably by a screen printing method.

11. Method according to claim 10, comprising the steps of:
(1) providing a substrate A;
(2) applying the conversion pigment by an application method, preferably by a printing method, particularly preferably by a screen printing method, in order to produce a conversion layer B;
(3) drying and/or polymerising and/or crosslinking the substrate A coated with the conversion layer B, in which case step (2) or step (3) or steps (2) and (3) may be respectively repeated one, two, three or more times individually and/or in alternation, the first performance of step (2) following step (1).

12. Method according to one of claims 10 and 11, characterised in that the substrate A is removed after one of the drying, polymerisation and/or crosslinking steps (3), preferably after the last step (3).

13. Conversion film, obtainable according to one of claims 10 and 11.

14. Use of a conversion film according to one of claims 1 to 9 or according to claim 13 for equipping light-emitting elements.

15. Device containing a light-emitting element, characterised in that the light-emitting element is covered by at least one conversion film according to one of claims 1 to 9 or according to claim 13.
